(19) United States
(12) Patent Application Publication
(10) Pub. No.: US 2024/0127093 A1
(43) Pub. Date: Apr. 18, 2024

(54) QUANTUM CIRCUIT OF COIFLET C6 WAVELET TRANSFORM AND INVERSE TRANSFORM AND MANUFACTURING METHOD THEREOF

(71) Applicant: NATIONAL CHENG KUNG UNIVERSITY, Tainan City (TW)

(72) Inventor: Chi-Chuan HWANG, Tainan City (TW)

(73) Assignee: NATIONAL CHENG KUNG UNIVERSITY, Tainan City (TW)

(21) Appl. No.: 17/988,676

(22) Filed: Nov. 16, 2022

(30) Foreign Application Priority Data
Sep. 30, 2022 (TW) 111137254

(51) Int. Cl. G06N 10/20; G06F 17/16

(52) U.S. Cl. CPC G06N 10/20; G06F 17/16

(57) ABSTRACT

A quantum circuit of Coiflet'C6 wavelet transform includes a B quantum circuit, a Q₂_{ⁿ}·Q₂_{ⁿ} quantum circuit, and an A quantum circuit. The B quantum circuit is configured to receive a first part of data of n-dimension and generate a first intermediate result. The Q₂_{ⁿ}·Q₂_{ⁿ} quantum circuit is configured to receive a second part of the data and generate a first result. The Q₂_{ⁿ}·Q₂_{ⁿ} quantum circuit is coupled to the B quantum circuit to receive the first intermediate result and generate a second intermediate result. The A quantum circuit is coupled to the Q₂_{ⁿ}·Q₂_{ⁿ} quantum circuit to receive the second intermediate result and generate a second result. The present disclosure also proposes a manufacturing method of a Coiflet'C6 wavelet transform quantum circuit and a Coiflet'C6 wavelet inverse transform quantum circuit.

### CROSS-REFERENCE TO RELATED APPLICATIONS

This non-provisional application claims priority under 35 U.S.C. § 119(a) on Patent Application No(s). 111137254 filed in Taiwan, ROC on Sep. 30, 2022, the entire contents of which are hereby incorporated by reference.

### BACKGROUND

### 1. Technical Field

This disclosure relates to a quantum circuit and a manufacturing method thereof, and more particular to a quantum circuit of Coiflet'C6 wavelet transform/inverse transform and manufacturing method thereof.

### 2. Related Art

Traditional discrete wavelet transform has been widely used in various fields such as image compression, audio analysis, etc. Common discrete wavelets include Daubechies wavelet and Coiflet wavelet. Daubechies wavelet can be abbreviated as DN where N is the length of the filter, and the commonly used range are D2 to D20. The function of Daubechies wavelet does not have symmetry, which will cause phase distortion during signal analysis. The Coiflet wavelet is an orthogonal wavelet with the property of high vanishing moments, and its waveform is nearly symmetric, so it has better signal output quality than Daubechies wavelet in image processing.

On the other hand, quantum computers have two characteristics, quantum superposition and quantum entanglement. They have more powerful computing power and controllability than traditional computers. The “quantum wavelet theory” combining wavelet transform and quantum computer will be an important tool for signal and image analysis in the future.

However, the research on quantum wavelet theory is still in its infancy, and the latest research on quantum wavelet transform is only carried out to Daubechies wavelet D4 transform. For the Coiflet wavelet, no research has yet combined it with quantum computers.

### SUMMARY

In view of the low benefit of the application result of the prior art solution (D4), the present disclosure proposes a Coiflet'C6 wavelet transform/inverse transform quantum circuit and a manufacturing method thereof, using more complex Coiflet'C6 wavelets to achieve better processing effect.

According to an embodiment of the present disclosure, a Coiflet'C6 wavelet transform quantum circuit includes a B quantum circuit, a Q₂_{ⁿ}·Q₂_{ⁿ} quantum circuit, and an A quantum circuit. The B quantum circuit is configured to receive a first part of data of n-dimension and generate a first intermediate result, where the first part comprises the data of (n−1)^{th} dimension and the data of n^{th} dimension. The Q₂_{ⁿ}·Q₂_{ⁿ} quantum circuit is configured to receive a second part of the data and generate a first result, where the Q₂_{ⁿ}·Q₂_{ⁿ} quantum circuit is coupled to the B quantum circuit to receive the first intermediate result and generate a second intermediate result, and the second part comprises the data of first dimension to the data of (n−2)^{th} dimension. The A quantum circuit is coupled to the Q₂_{ⁿ}·Q₂_{ⁿ} quantum circuit to receive the second intermediate result and generate a second result, where n is a positive integer, the B quantum circuit and the A quantum circuit are configured to implement two 4×4 parameter matrixes, the Q₂_{ⁿ}·Q₂_{ⁿ} quantum circuit is configured to implement a dot product of two identical unitary matrixes, the two identical unitary matrixes are configured to transfer a state amplitude of qubits, and the Coiflet'C6 wavelet transform quantum circuit outputs a set of the first result and the second result.

According to an embodiment of the present disclosure, a manufacturing method of a Coiflet'C6 wavelet transform quantum circuit includes: decomposing a matrix C₂_{ⁿ}⁽⁶⁾ of a Coiflet'C6 wavelet into (I₂_{^{n−2}}⊗A)·Q₂_{ⁿ}·Q₂_{ⁿ}·(I₂_{^{n−2}}⊗B), decomposing the A into U₁ₐ⊕U₂ₐ·SCₐV₁ₐ^{T}⊕V₂ₐ^{T}, decomposing the B into U_{1b}⊕U_{2b}·SC_{b}V_{1b}^{T}⊕V_{2b}^{T}, and constructing the Coiflet'C6 wavelet transform quantum circuit by a plurality of qubit logic gates according to the (I₂_{^{n−2}}⊗A)·Q₂_{ⁿ}·Q₂_{ⁿ}·(I₂_{^{n−2}}⊗B) , the U₁ₐ⊕U₂ₐ·SCₐ·V₁ₐ^{T}⊕V₂ₐ^{T}, and the U_{1b}⊕U_{2b}·SC_{b}·V_{1b}^{T}⊕V_{2b}^{T}, where the Q₂_{ⁿ} is a 2ⁿ×2ⁿ unitary matrix , the U₁ₐ is

$$Ph ( \frac{π}{2} ) \cdot {R}_{z} ( π ) \cdot {R}_{y} ( 1.86504 π ) \cdot {R}_{z} ( 0 ) ,$$

### the U₂ₐ is

$$Ph ( \frac{π}{2} ) \cdot {R}_{z} ( π ) \cdot {R}_{y} ( 0.86504 π ) \cdot {R}_{z} ( 2 π ) ,$$

the SCₐ is R_{y}(0)⊕R_{y}(−0.23π) , the V₁ₐ^{T} and the V₂ₐ^{T} are Pauli-Z gates, the U_{1b} and the U_{2b} are Pauli-X gates, the SC_{b} is R_{y}(0)⊕R_{y}(0.23π), the V₂ₐ^{T} is Ph(π)·R_{z}(π)·R_{y}(0.13495π)·R_{z}(0) , the V_{2b}^{T} is Ph(π)·R_{z}(π)·R_{y}(1.13496π)·R_{z}(π), the Ph is a phase-shift gate, the R_{z} is a rotation-Z gate, and the R_{y} is a rotation-Y gate.

According to an embodiment of the present disclosure, a Coiflet'C6 wavelet inverse transform quantum circuit includes an (A)⁻¹ quantum circuit, a (Q₂_{ⁿ})⁻¹·(Q₂_{ⁿ})⁻¹ quantum circuit, and a (B)⁻¹ quantum circuit. The (A)⁻¹ quantum circuit is configured to receive a first part of data of n-dimension and generate a first intermediate result, where the first part comprises the data of (n−1)^{th} dimension and the data of n^{th} dimension. The (Q₂_{ⁿ})⁻¹·(Q₂_{ⁿ})⁻¹ quantum circuit is configured to receive a second part of the data and generate a first result, where the (Q₂_{ⁿ})⁻¹·(Q₂_{ⁿ})⁻¹ quantum circuit is coupled to the (A)⁻¹ quantum circuit to receive the first intermediate result and generate a second intermediate result, and the second part comprises the data of first dimension to the data of (n−2)^{th} dimension. The (B)⁻¹ quantum circuit is coupled to the (Q₂_{ⁿ})⁻¹·(Q₂_{ⁿ})⁻¹ quantum circuit to receive the second intermediate result and generate a second result. where n is a positive integer, the (A)⁻¹ quantum circuit and the (B)⁻¹ quantum circuit are configured to implement inverse matrixes of two 4×4 parameter matrixes, the (Q₂_{ⁿ})⁻¹·(Q₂_{ⁿ})⁻¹ quantum circuit is configured to implement a dot product of inverse matrixes of two identical unitary matrixes, the two identical unitary matrixes are configured to transfer a state amplitude of qubits, and the Coiflet'C6 wavelet inverse transform quantum circuit outputs a set of the first result and the second result.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1A to FIG. 1I are component symbol diagrams of 1-qubit logic gates configured to construct the Coiflet'C6 wavelet transform quantum circuit according to an embodiment of the present disclosure;

FIG. 2A and FIG. 2B are component symbol diagrams of 2-qubit logic gates configured to construct the Coiflet'C6 wavelet transform quantum circuit according to an embodiment of the present disclosure;

FIG. 2C is a component symbol diagram of 3-qubit logic gates configured to construct the Coiflet'C6 wavelet transform quantum circuit according to an embodiment of the present disclosure

FIG. 3A and FIG. 3B are circuit diagrams of reversal permutation of qubits;

FIG. 4 is a circuit diagram of the Coiflet'C6 wavelet transform quantum circuit according to an embodiment of the present disclosure;

FIG. 5 is a circuit diagram of the B quantum circuit in the Coiflet'C6 wavelet transform quantum circuit according to an embodiment of the present disclosure;

FIG. 6 is a circuit diagram of the A quantum circuit in the Coiflet'C6 wavelet transform quantum circuit according to an embodiment of the present disclosure;

FIG. 7 is a circuit diagram of the Q₂_{ⁿ}·Q₂_{ⁿ} quantum circuit in the Coiflet'C6 wavelet transform quantum circuit according to an embodiment of the present disclosure;

FIG. 8A to FIG. 8E are logic gate representations of the B quantum circuit in the Coiflet'C6 wavelet transform quantum circuit according to an embodiment of the present disclosure;

FIG. 9A to FIG. 9E are logic gate representations of the A quantum circuit in the Coiflet'C6 wavelet transform quantum circuit according to an embodiment of the present disclosure;

FIG. 10 is a structural diagram of circuit expansion of the Coiflet'C6 wavelet transform quantum circuit according to an embodiment of the present disclosure;

FIG. 11 is a flowchart of a manufacturing method of a Coiflet'C6 wavelet transform quantum circuit according to an embodiment of the present disclosure;

FIG. 12 is a circuit diagram of the Coiflet'C6 wavelet inverse transform quantum circuit according to an embodiment of the present disclosure;

FIG. 13 is a circuit diagram of the (A)⁻¹ quantum circuit in the Coiflet'C6 wavelet inverse transform quantum circuit according to an embodiment of the present disclosure;

FIG. 14 is a circuit diagram of the (B)⁻¹ quantum circuit in the Coiflet'C6 wavelet inverse transform quantum circuit according to an embodiment of the present disclosure;

FIG. 15 is a circuit diagram of the (Q₂_{ⁿ})⁻¹·(Q₂_{ⁿ})⁻¹ quantum circuit in the Coiflet'C6 wavelet inverse transform quantum circuit according to an embodiment of the present disclosure; and

FIG. 16 is a structural diagram of circuit expansion of the Coiflet'C6 wavelet inverse transform quantum circuit according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

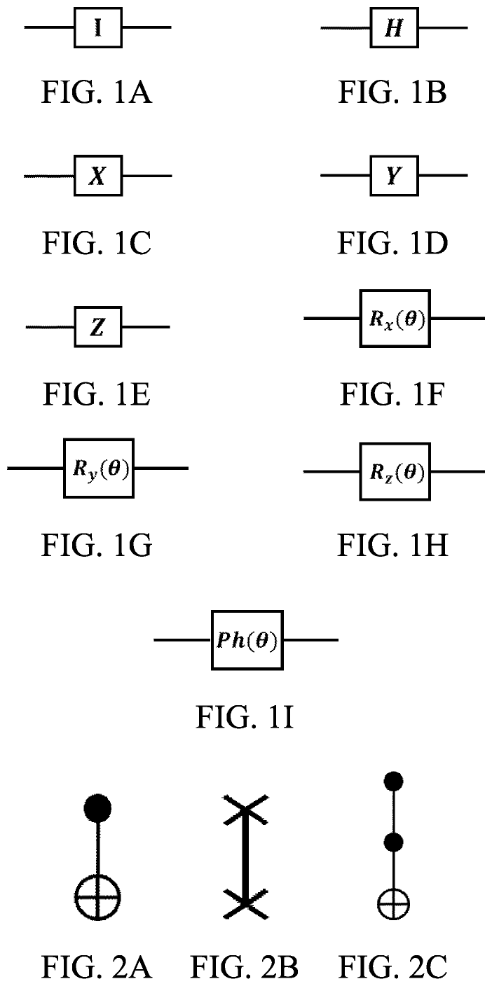

The present disclosure proposes Coiflet'C6 wavelet transform/inverse transform quantum circuits based on a matrix form of Coiflet'C6 wavelet. This quantum circuit may be composed of a plurality of qubit logic gates. FIG. 1A to FIG. 11 are component symbol diagrams of 1-qubit logic gates configured to construct the Coiflet'C6 wavelet transform quantum circuit according to an embodiment of the present disclosure. These diagrams correspond to the identity gate, Hadamard gate, Pauli-X gate, Pauli-Y gate, Pauli-Z gate, Rotation-X gate, Rotation-Y gate, Rotation-Z gate, and Phase-Shift gate, respectively

FIG. 2A and FIG. 2B are component symbol diagrams of 2-qubit logic gates configured to construct the Coiflet'C6 wavelet transform quantum circuit according to an embodiment of the present disclosure. FIG. 2C is a component symbol diagram of 3-qubit logic gates configured to construct the Coiflet'C6 wavelet transform quantum circuit according to an embodiment of the present disclosure. These diagrams correspond to the controlled-NOT gate (CNOT), swap gate, and Toffoli gate.

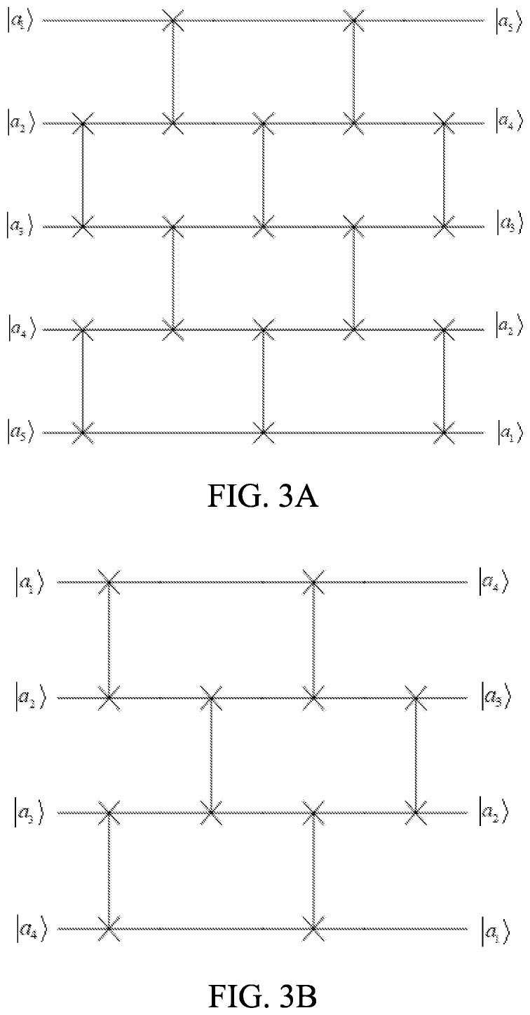

FIG. 3A and FIG. 3B are circuit diagrams of reversal permutation of qubits. In quantum circuits, the quantum state description of qubit reversal permutation P₂_{ⁿ} is shown as Equation 1 below:

P₂_{ⁿ}|aₙ₋₁aₙ₋₂ . . . a₁a₀ [symbol] =|a₀a₁ . . . aₙ₋₂aₙ₋₁ [symbol] (Equation 1)

When there are n qubits, the total number of quantum states will be 2ⁿ. When an operation of reversal permutation on P₂_{ⁿ} is performed, the circuit may be different due to the different number of qubits. When n is odd, the circuit diagram of P₂_{ⁿ} is shown as FIG. 3A. When n is even, the circuit diagram of P₂_{ⁿ} is shown as FIG. 3B.

In an embodiment, the matrix form of Coiflect'C6 wavelet C₂_{ⁿ}⁽⁶⁾ is a 2ⁿ×2ⁿ matrix, as Equation 2 shown below:

$${C}_{{2}^{n}}^{( 6 )} = [ \begin{matrix}{c}_{0} & {c}_{1} & {c}_{2} & {c}_{3} & {c}_{4} & {c}_{5} & 0 & 0 & ⋯ & 0 & 0 & 0 & 0 & 0 & 0 \\ {c}_{5} & - {c}_{4} & {c}_{3} & - {c}_{2} & {c}_{1} & - {c}_{0} & 0 & 0 & ⋯ & 0 & 0 & 0 & 0 & 0 & 0 \\ 0 & 0 & {c}_{0} & {c}_{1} & {c}_{2} & {c}_{3} & {c}_{4} & {c}_{5} & ⋯ & 0 & 0 & 0 & 0 & 0 & 0 \\ 0 & 0 & {c}_{5} & - {c}_{4} & {c}_{3} & - {c}_{2} & {c}_{1} & - {c}_{0} & ⋯ & 0 & 0 & 0 & 0 & 0 & 0 \\ ⋮ & ⋮ & ⋮ & ⋮ & ⋮ & ⋮ & ⋮ & ⋮ & ⋱ & 0 & 0 & 0 & 0 & 0 & 0 \\ 0 & 0 & 0 & 0 & 0 & 0 & 0 & 0 & ⋯ & {c}_{o} & {c}_{1} & {c}_{2} & {c}_{3} & {c}_{4} & {c}_{5} \\ 0 & 0 & 0 & 0 & 0 & 0 & 0 & 0 & ⋯ & {c}_{5} & - {c}_{4} & {c}_{3} & - {c}_{2} & {c}_{1} & - {c}_{0} \\ {c}_{4} & {c}_{5} & 0 & 0 & 0 & 0 & 0 & 0 & ⋯ & 0 & 0 & {c}_{0} & {c}_{1} & {c}_{2} & {c}_{3} \\ {c}_{1} & - {c}_{0} & 0 & 0 & 0 & 0 & 0 & 0 & ⋯ & 0 & 0 & {c}_{5} & - {c}_{4} & {c}_{3} & - {c}_{2} \\ {c}_{2} & {c}_{3} & {c}_{4} & {c}_{5} & 0 & 0 & 0 & 0 & ⋯ & 0 & 0 & 0 & 0 & {c}_{0} & {c}_{1} \\ {c}_{3} & - {c}_{2} & {c}_{1} & - {c}_{0} & 0 & 0 & 0 & 0 & ⋯ & 0 & 0 & 0 & 0 & {c}_{5} & - {c}_{4}\end{matrix} ] \qquad ( Equation 2 )$$

The parameters c₀ to c₅ in the matrix are shown below:

$${c}_{0} = \frac{1}{16 \sqrt{2}} ( 1 - \sqrt{7} ) \approx - 0.072733 ;$$

$${c}_{1} = \frac{1}{16 \sqrt{2}} ( 5 + \sqrt{7} ) \approx 0.3 \; 37898 ;$$

$${c}_{2} = \frac{1}{8 \sqrt{2}} ( 7 + \sqrt{7} ) \approx 0.8 \; 52572 ;$$

$${c}_{3} = \frac{1}{8 \sqrt{2}} ( 7 - \sqrt{7} ) \approx 0.3 \; 84865 ;$$

$${c}_{4} = \frac{1}{16 \sqrt{2}} ( 1 - \sqrt{7} ) \approx - 0.0 \; 72733 ;$$

$$and$$

$${c}_{5} = \frac{1}{16 \sqrt{2}} ( - 3 + \sqrt{7} ) \approx - 0.015656 .$$

It is known that any 1-qubit logic gate U may be decomposed as Equation 3 below:

U=Ph(δ)·R_{z}(γ)·R_{y}(β)·R_{z}(α) (Equation 3),
where the Ph is a phase-shift gate, the R_{z} is a rotation-Z gate, the R_{y} is a rotation-Y gate, and the Rₓ is a rotation-X gate.

Based on Equation 3 and Singular Value Decomposition (SVD), C₂_{ⁿ}⁽⁶⁾ may be decomposed into Equation 4 below:

C₂_{ⁿ}⁽⁶⁾=(I₂_{^{n−2}}⊗A)·Q₂_{ⁿ}·Q₂_{ⁿ}(I₂_{^{n−2}}⊗B) (Equation 4),
where I₂_{^{n−2}} is a 2ⁿ⁻²×2ⁿ⁻² identity matrix, A and B are 4×4 parameter matrixes, Q₂_{ⁿ} is a 2ⁿ×2ⁿ unitary matrix, ⊗ denotes direct sum, and denotes dot product. In quantum circuits, the direct sum is formed by multiple quantum logic gates arranging in parallel up and down. The present disclosure reduces the dimension of the matrix C₂_{ⁿ}⁽⁶⁾ with high data dimension and complex coefficient relationship to two parameter matrixes A and B with only 4×4 matrix complexity, and then realizes the Coiflet'C6 wavelet transform quantum circuit.

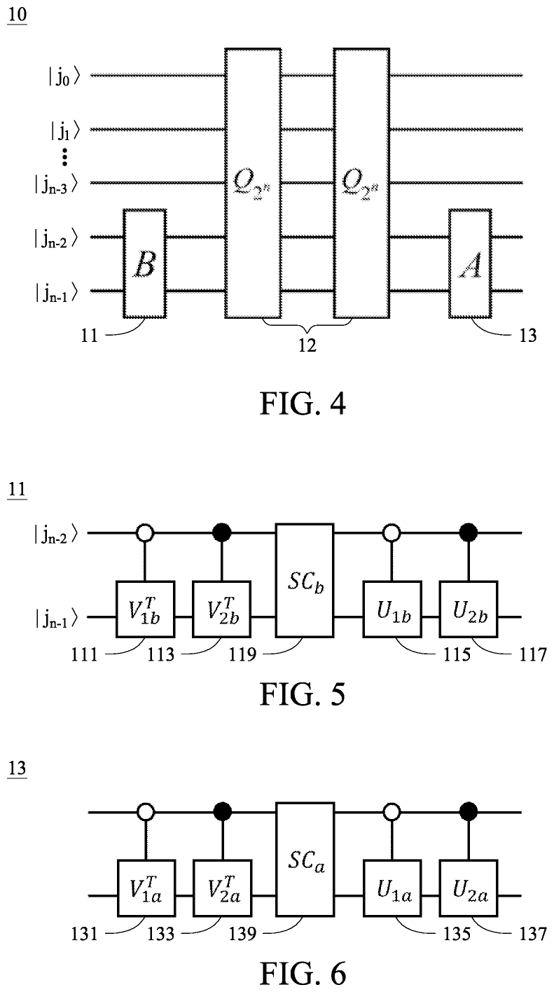

Therefore, the Coiflet'C6 wavelet transform quantum circuit may be implemented according to Equation 4. FIG. 4 is a circuit diagram of the Coiflet'C6 wavelet transform quantum circuit according to an embodiment of the present disclosure. As shown in FIG. 4, the Coiflet'C6 wavelet transform quantum circuit 10 includes a B quantum circuit 11, a Q₂_{ⁿ}·Q₂_{ⁿ} quantum circuit 12, and an A quantum circuit 13, where n is a positive integer represent the number of qubits.

The input of the Coiflet'C6 wavelet transform quantum circuit 10 are data of n dimensions, including |j₀ [symbol] , |j₁ [symbol] , . . . , |jₙ₋₃ [symbol] , |jₙ₋₂ [symbol] , |jₙ₋₁ [symbol] . The data are divided into a first part and a second part. The first part includes data of the (n−1)^{th} dimension |jₙ₋₂ [symbol] and the data of the n^{th} dimension |jₙ₋₁ [symbol] . The second part includes the data of the first dimension |j₀ [symbol] to the data of the (n−2)^{th} dimension |jₙ₋₃ [symbol] . The B quantum circuit 11 is configured to receive the first part of data of n-dimension and generate a first intermediate result. The Q₂_{ⁿ}·Q₂_{ⁿ} quantum circuit 12 is coupled to the B quantum circuit 11 to receive the first intermediate result and generate a second intermediate result according to the first intermediated result. In addition, the Q₂_{ⁿ}·Q₂_{ⁿ} quantum circuit 12 receives the second part of the data and generate a first result according to the second part. The A quantum circuit 13 is coupled to the Q₂_{ⁿ}·Q₂_{ⁿ} quantum circuit 12 to receive the second intermediate result and generate a second result according to the second intermediate result. The output of the Coiflet'C6 wavelet transform quantum circuit 10 is a set of the first result and the second result, where the first result is the output of the Q₂_{ⁿ}·Q₂_{ⁿ} quantum circuit 12, and the second result is the output of the A quantum circuit 13.

16 solutions of A, B may be obtained by solving simultaneous equations according to Equation 2 and Equation 4, where the solution of minimal circuit complexity is shown as Equation 5 and Equation 6 below:

$$A = [ \begin{matrix}- 0.9776 & 0.19678 & 0 & 0.07437 \\ - 0.2104 & - 0.91434 & 0 & - 0.34558 \\ 0 & 0.34558 & - 0.2104 & - 0.91434 \\ 0 & 0.07437 & 0.9776 & - 0.19678\end{matrix} ] \qquad ( Equation 5 )$$

$$B = [ \begin{matrix}0.19678 & - 0.91434 & 0.34558 & 0.07437 \\ - 0.9776 & - 0.2104 & 0 & 0 \\ 0.07437 & - 0.34558 & - 0.91434 & - 0.19678 \\ 0 & 0 & - 0.2104 & 0.9776\end{matrix} ] \qquad ( Equation 6 )$$

Therefore, the A quantum circuit 13 and the B quantum circuit 11 are configured to implement two 4×4 parameter matrixes. Through Cosine-Sine Decomposition (CSD), the Equation 5 and Equation 6 may be decomposed into Equation 7 and Equation 8 respectively:

A=U₁ₐ⊕U₂ₐ·SCₐ·V₁ₐ^{T}⊕V₂ₐ^{T} (Equation 7),

B=U_{1b}⊕U_{2b}·SC_{b}·V_{1b}^{T}⊕V_{2b}^{T} (Equation 8),
where ⊕ denotes direct sum. In quantum circuits, the direct sum operation represents a circuit composed of a series of control quantum logic gates, using the value of the control qubit to determine whether the target qubit will be acted on by the quantum logic gate.

Each term of the matrix A of Equation 7 is shown below:

$${U}_{1 a} = [ \begin{matrix}- 0.9776 & - 0.2104 \\ - 0.2104 & 0.9776\end{matrix} ] ,$$

$${U}_{2 a} = [ \begin{matrix}- 0.2104 & 0.9776 \\ 0.9776 & 0.2104\end{matrix} ] ,$$

$${V}_{1 a}^{T} = [ \begin{matrix}1 & 0 \\ 0 & - 1\end{matrix} ] ,$$

$${V}_{2 a}^{T} = [ \begin{matrix}1 & 0 \\ 0 & - 1\end{matrix} ] ,$$

$$and$$

$${SC}_{a} = [ \begin{matrix}cos {θ}_{a 1} & 0 & sin {θ}_{a 1} & 0 \\ 0 & cos {θ}_{a 2} & 0 & sin {θ}_{a 2} \\ - sin {θ}_{a 1} & 0 & cos {θ}_{a 1} & 0 \\ 0 & - sin {θ}_{a 2} & 0 & cos {θ}_{a 2}\end{matrix} ] ,$$

where θₐ₁=0, θₐ₂=0.115π.

Each term of the matrix B of Equation 8 is shown below:

$${U}_{1 b} = [ \begin{matrix}0 & 1 \\ 1 & 0\end{matrix} ] ,$$

$${U}_{2 b} = [ \begin{matrix}0 & 1 \\ 1 & 0\end{matrix} ] ,$$

$${V}_{1 b}^{T} = [ \begin{matrix}- 0.9776 & 0.2104 \\ - 0.2104 & - 0.9776\end{matrix} ] ,$$

$${V}_{2 b}^{T} = [ \begin{matrix}- 0.2104 & - 0.9776 \\ 0.9776 & - 0.2104\end{matrix} ] ,$$

$$and {SC}_{b} = [ \begin{matrix}cos {θ}_{b 1} & 0 & sin {θ}_{b 1} & 0 \\ 0 & cos {θ}_{b 2} & 0 & sin {θ}_{b 2} \\ - sin {θ}_{b 1} & 0 & cos {θ}_{b 1} & 0 \\ 0 & - sin {θ}_{b 2} & 0 & cos {θ}_{b 2}\end{matrix} ] ,$$

where θ_{b1}=0, θ_{b2}=−0.115π.

Therefore, the A quantum circuit 13 may be implemented according to Equation 7 and the B quantum circuit 11 may be implemented according to Equation 8. Please refer to FIG. 5 and FIG. 6. FIG. 5 is a circuit diagram of the B quantum circuit 11 in the Coiflet'C6 wavelet transform quantum circuit 10 according to an embodiment of the present disclosure, and FIG. 6 is a circuit diagram of the A quantum circuit 13 in the Coiflet'C6 wavelet transform quantum circuit 10 according to an embodiment of the present disclosure.

As shown in FIG. 5 and FIG. 6, the B quantum circuit 11 includes sub-circuits 111, 113, 115, 117, and 119. The combination of these sub-circuits is configured to implement U_{1b}⊕U_{2b}·SC_{b}·V_{1b}^{T}⊕V_{2b}^{T}. The A quantum circuit 13 includes sub-circuits 131, 133, 135, 137, and 139. The combination of these sub-circuits is configured to implement U₁ₐ⊕U₂ₐ·SCₐ·V₁ₐ^{T}⊕V₂ₐ^{T}. In quantum circuits, when the logic gates are arranged from left to right, they act from right to left.

The Q₂_{ⁿ}·Q₂_{ⁿ} quantum circuit 12 is configured to implement a dot product of two identical unitary matrixes Q₂_{ⁿ}, Q₂_{ⁿ} these two identical unitary matrixes Q₂_{ⁿ}, Q₂_{ⁿ} are configured to transfer a state amplitude of qubits. Specifically, in quantum circuits, Q₂_{ⁿ} may shift the state amplitude of qubits to the left, and (Q₂_{ⁿ})⁻¹ may shift the state amplitude of qubits to the right. The matrix form of Q₂_{ⁿ} is shown as Equation 9 below:

$${Q}_{{2}^{n}} = [ \begin{matrix}0 & 1 & 0 & 0 & … & 0 \\ 0 & 0 & 1 & 0 & … & 0 \\ 0 & 0 & 0 & 1 & … & 0 \\ ⋮ & ⋮ & ⋮ & ⋮ & ⋱ & 0 \\ 0 & 0 & 0 & 0 & … & 1 \\ 1 & 0 & 0 & 0 & … & 0\end{matrix} ] \qquad ( Equation 9 )$$

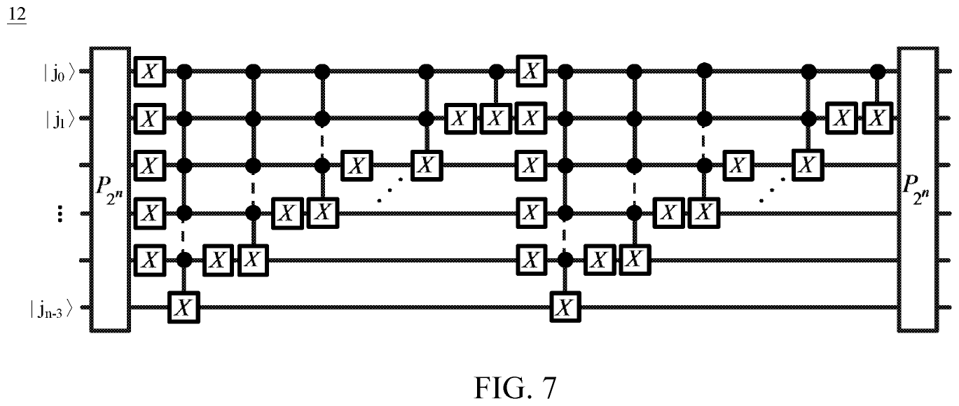

Therefore, the Q₂_{ⁿ}·Q₂_{ⁿ} quantum circuit 12 may be expanded and implemented according to Equation 9. FIG. 7 is a circuit diagram of the Q₂_{ⁿ}·Q₂_{ⁿ} quantum circuit 12 in the Coiflet'C6 wavelet transform quantum circuit 10 according to an embodiment of the present disclosure. As described in the above, the Q₂_{ⁿ}·Q₂_{ⁿ} quantum circuit 12 is configured to receive a second part of the data and generate a first result. The second part includes the data of the first dimension ⊕j₀ [symbol] to the data of the (n−2)^{th} dimension ⊕jₙ₋₃ [symbol] .

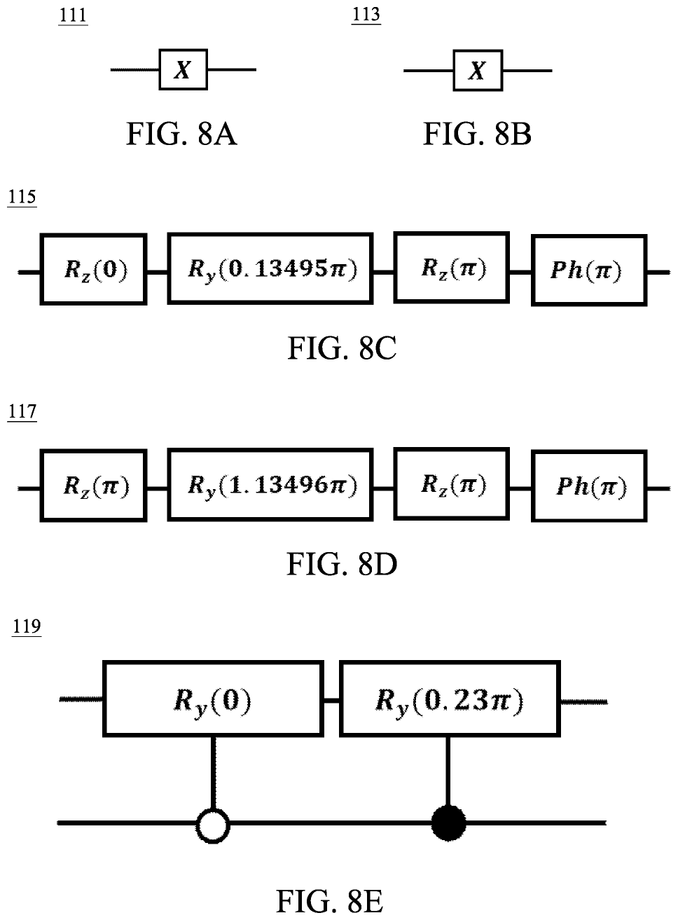

Please refer to FIG. 5 and FIG. 8A to FIG. 8E together. FIG. 8A to FIG. 8E are respectively an embodiment of the sub-circuits 111 to 119 of the B quantum circuit 11.

As shown in FIG. 8A and FIG. 8B, the sub-circuit 111 and the sub-circuit 113 are Pauli-X gates.

As shown in FIG. 8C, the sub-circuit 115 is configured to implement Ph(π)·R_{z}(π)·R_{y}(0.13495π)·R_{z}(0).

As shown in FIG. 8D, the sub-circuit 117 is configured to implement Ph(π)·R_{z}(π)·R_{y}(1.13496π)·R_{z}(π).

As shown in FIG. 8E, the sub-circuit 119 is configured to implement R_{y}(0)⊕R_{y}(−0.23π).

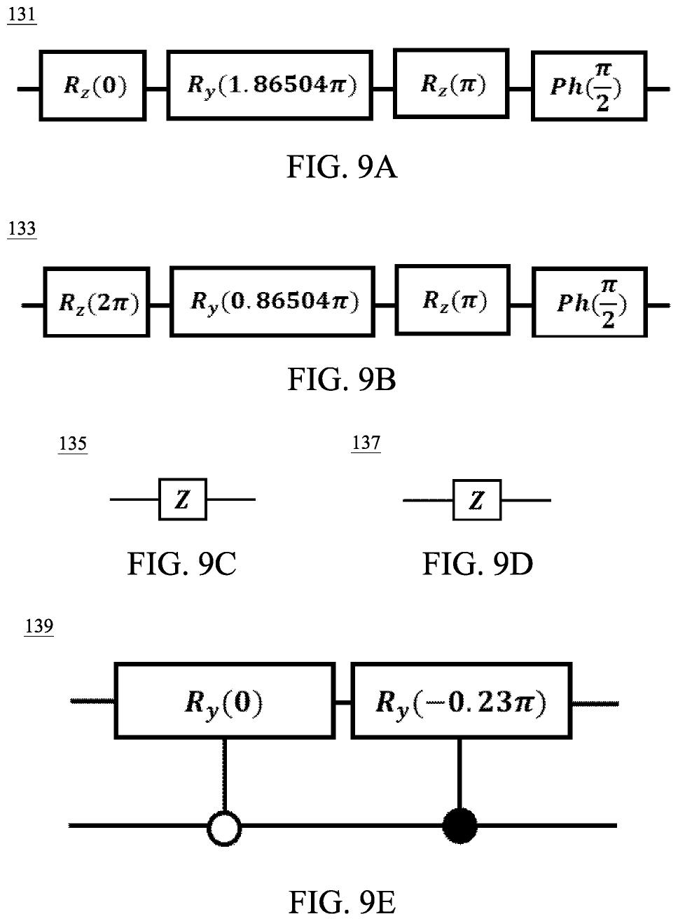

Please refer to FIG. 6 and FIG. 9A to FIG. 9E together. FIG. 9A to FIG. 9E are respectively an embodiment of the sub-circuits 131 to 139 of the A quantum circuit 13.

As shown in FIG. 9A, the sub-circuit 131 is configured to implement

$$Ph ( \frac{π}{2} ) \cdot {R}_{z} ( π ) \cdot {R}_{y} ( 1.86504 π ) \cdot {R}_{z} ( 0 ) .$$

As shown in FIG. 9B, the sub-circuit 133 is configured to implement

$$Ph ( \frac{π}{2} ) \cdot {R}_{z} ( π ) \cdot {R}_{y} ( 0.86504 π ) \cdot {R}_{z} ( 2 π ) .$$

As shown in FIG. 9C and FIG. 9D, the sub-circuit 135 and the sub-circuit 137 are Pauli-Z gates.

As shown in FIG. 9E, the sub-circuit 119 is configured to implement R_{y}(0)⊕R_{y}(−0.23π).

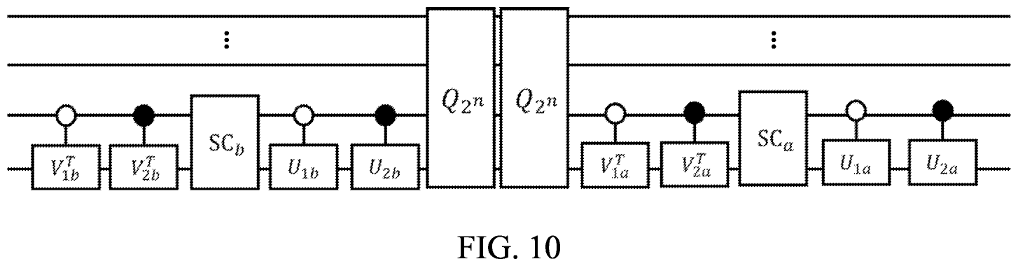

FIG. 10 is a schematic diagram expanding the circuits shown in FIG. 5 and FIG. 6 to FIG. 4. By the above manner, an embodiment of the present disclosure uses qubit logic gates and quantum arrangement to implement the quantum circuit of Coiflet'C6 wavelet transform. In this embodiment, the huge matrix corresponding to Coiflet'C6 wavelet is simplified into a combination form of dot product, direct product and direct sum, with the matrix reduction and matrix decomposition being carried out step by step. Then the simplified result is converted into basic quantum logic gates, with 1-qubit logic gates and CNOT logic gate as the basis of circuit design. Finally, the design of Coiflet'C6 wavelet transform on the quantum circuit is completed.

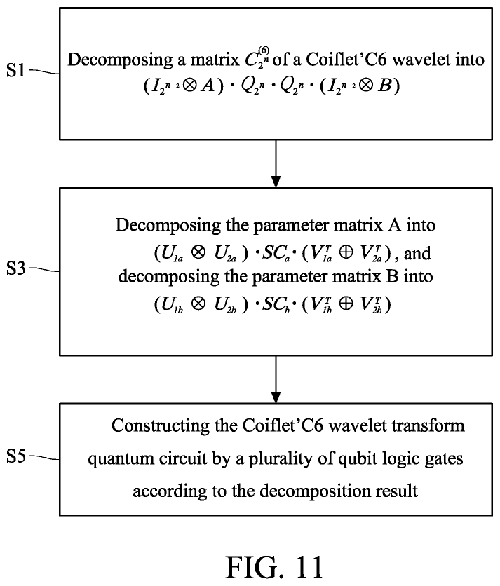

FIG. 11 is a flowchart of a manufacturing method of a Coiflet'C6 wavelet transform quantum circuit according to an embodiment of the present disclosure. In order to generate the aforementioned Coiflet'C6 wavelet transform quantum circuit 10, the following steps may be performed by a computing device and in conjunction with quantum logic gates.

In step S1, the computing device decomposes a matrix C₂_{ⁿ}⁽⁶⁾ of a Coiflet'C6 wavelet into (I₂_{^{n−2}}⊗A)·Q₂_{ⁿ}·Q₂_{ⁿ}·(I₂_{^{n−2}}⊗B). In step S3, the computing device decomposes the parameter matrix A into U₁ₐ⊕U₂ₐ·SCₐ·V₁ₐ^{T}⊕V₂ₐ^{T}, and decomposes the parameter matrix B into U_{1b}⊕U_{2b}·SC_{b}·V_{1b}^{T}⊕V_{2b}^{T}. In step S5, multiple qubit logic gates are used to construct the Coiflet'C6 wavelet transform quantum circuit 20 according to the (I₂_{^{n−2}}⊗A)·Q₂_{ⁿ}·Q₂_{ⁿ}·(I₂_{^{n−2}}⊗B), the U₁ₐ⊕U₂ₐ·SCₐ·V₁ₐ^{T}⊕V₂ₐ^{T}, and the U_{1b}⊕U_{2b}·SC_{b}·V_{1b}^{T}⊕V_{2b}^{T}. In the above steps, the Q₂_{ⁿ} is a 2ⁿ×2ⁿ unitary matrix, the U₁ₐ is

$$Ph ( \frac{π}{2} ) \cdot {R}_{z} ( π ) \cdot {R}_{y} ( 1.86504 π ) \cdot {R}_{z} ( 0 ) ,$$

### the U₂ₐ is

$$Ph ( \frac{π}{2} ) \cdot {R}_{z} ( π ) \cdot {R}_{y} ( 0.86504 π ) \cdot {R}_{z} ( 2 π ) ,$$

the SCₐ is R_{y}(0)⊕R_{y}(−0.23π) , the V₁ₐ^{T} and the V₂ₐ^{T} are Pauli-Z gates, the U_{1b} and the U_{2b} are Pauli-X gates, the SC_{b} is R_{y}(0)⊕R_{y}(0.23π), the V_{1b}^{T} is Ph(π)·R_{z}(π)·R_{y}(0.13495π)·R_{z}(0), the V_{2b}^{T} is Ph(π)·R_{z}(π)·R_{y}(1.13496π)·R_{z}(π), the Ph is a phase-shift gate, the R_{z} is a rotation-Z gate, and the R_{y} is a rotation-Y gate.

In another embodiment of the present disclosure, a Coiflet'C6 wavelet inverse transform quantum circuit is implemented. Specifically, according to Equation 4 and matrix operation,

$${( {C}_{{2}^{n}}^{( 6 )} )}^{- 1}$$

may be decomposed as Equation 10 below:

$${( {C}_{{2}^{n}}^{( 6 )} )}^{- 1} = ( {I}_{{2}^{n - 2}} ⊗ {( B )}^{- 1} ) \cdot {( {Q}_{{2}^{n}} )}^{- 1} \cdot {( {Q}_{{2}^{n}} )}^{- 1} \cdot ( {I}_{{2}^{n - 2}} ⊗ {( A )}^{- 1} )$$

### (Equation 10)

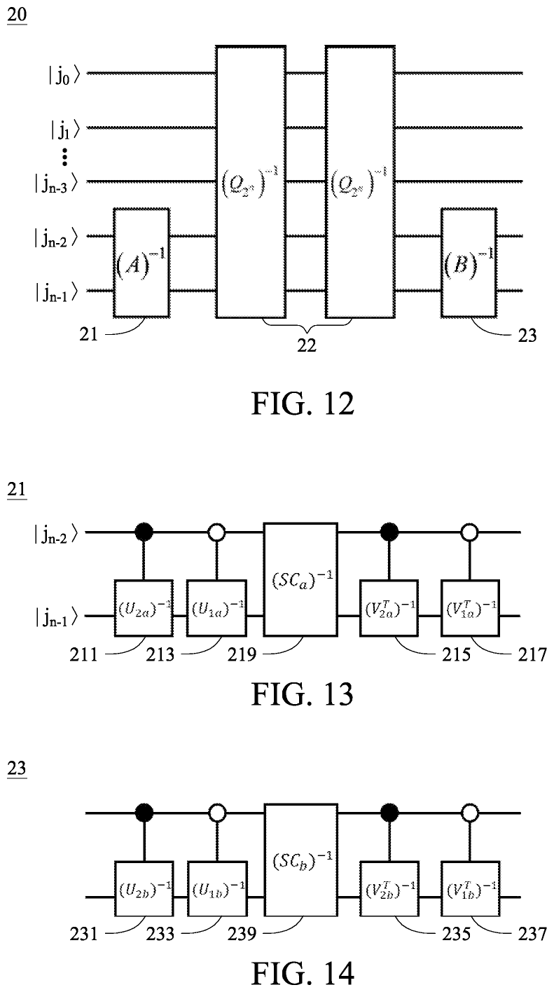

Therefore, the Coiflet'C6 wavelet inverse transform quantum circuit may be implemented according to Equation 10. FIG. 12 is a circuit diagram of the Coiflet'C6 wavelet inverse transform quantum circuit according to an embodiment of the present disclosure. As shown in FIG. 12, the Coiflet'C6 wavelet inverse transform quantum circuit 20 includes an (A)⁻¹ quantum circuit 21, a (Q₂_{ⁿ})⁻¹·(Q₂_{ⁿ})⁻¹ quantum circuit 22, an (B)⁻¹ quantum circuit 23, where n is a positive integer representing the number of qubits.

The input of the Coiflet'C6 wavelet inverse transform quantum circuit 20 are data of n dimensions, including |j₀ [symbol] , |j₁ [symbol] , . . . , |jₙ₋₃ [symbol] , |jₙ₋₂ [symbol] , |jₙ₋₁ [symbol] . The data are divided into a first part and a second part. The first part includes data of the (n−1)^{th} dimension |jₙ₋₂ [symbol] and the data of the n^{th} dimension |jₙ₋₁ [symbol] . The second part includes the data of the first dimension |j₀ [symbol] to the data of the (n−2)^{th} dimension |jₙ₋₃ [symbol] . The (A)⁻¹ quantum circuit 21 is configured to receive the first part of data of n-dimension and generate a first intermediate result. The (Q₂_{ⁿ})⁻¹·(Q₂_{ⁿ})⁻¹ quantum circuit 22 is coupled to the (A)⁻¹ quantum circuit 21 to receive the first intermediate result and generate a second intermediate result according to the first intermediated result. In addition, the (Q₂_{ⁿ})⁻¹·(Q₂_{ⁿ})⁻¹ quantum circuit 22 receives the second part of the data and generate a first result according to the second part. The (B)⁻¹ quantum circuit 23 is coupled to the (Q₂_{ⁿ})⁻¹·(Q₂_{ⁿ})⁻¹ quantum circuit 22 to receive the second intermediate result and generate a second result according to the second intermediate result. The output of the Coiflet'C6 wavelet inverse transform quantum circuit 20 is a set of the first result and the second result, where the first result is the output of the (Q₂_{ⁿ})⁻¹·(Q₂_{ⁿ})⁻¹ quantum circuit 22, and the second result is the output of the (B)⁻¹quantum circuit 23.

Therefore, the (A)⁻¹ quantum circuit 21 and the (B)⁻¹ quantum circuit 23 are configured to implement two 4×4 parameter matrixes. Equation 11 and Equation 12 may be obtained according to Equation 7, Equation 8, and the matrix operation:

(A)⁻¹=(V₂ₐ^{T})⁻¹⊕(V₁ₐ^{T})⁻¹·(SCₐ)⁻¹·(U₂ₐ)⁻¹⊕(U₁ₐ)⁻¹ (Equation 11),

(B)⁻¹=(V_{2b}^{T})⁻¹⊕(V_{1b}^{T})⁻¹·(SC_{b})⁻¹·(U_{2b})⁻¹⊕(U_{1b})⁻¹ (Equation 12),

Therefore, the (A)⁻¹ quantum circuit 21 may be implemented according to Equation 11 and the (B)⁻¹ quantum circuit 23 may be implemented according to Equation 12. Please refer to FIG. 13 and FIG. 14. FIG. 13 is a circuit diagram of the (A)⁻¹ quantum circuit 21 in the Coiflet'C6 wavelet inverse transform quantum circuit 20 according to an embodiment of the present disclosure, and FIG. 14 is a circuit diagram of the (B)⁻¹ quantum circuit 23 in the Coiflet'C6 wavelet inverse transform quantum circuit 20 according to an embodiment of the present disclosure.

As shown in FIG. 13 and FIG. 14, the (A)⁻¹ quantum circuit 21 includes sub-circuits 211, 213, 215, 217, and 219. The combination of these sub-circuits is configured to implement (V₂ₐ^{T})⁻¹⊕(V₁ₐ^{T})⁻¹·(SCₐ)⁻¹·(U₂ₐ)⁻¹⊕(U₁ₐ)⁻¹. The (B)⁻¹ quantum circuit 23 includes sub-circuits 231, 233, 235, 237, and 239. The combination of these sub-circuits is configured to implement (V_{2b}^{T})⁻¹⊕(V_{1b}^{T})⁻¹·(SC_{b})⁻¹·(U_{2b})⁻¹⊕(U_{1b})⁻¹.

The (Q₂_{ⁿ})⁻¹·(Q₂_{ⁿ})⁻¹ quantum circuit 22 is configured to implement a dot product of inverse matrixes of two identical unitary matrixes (Q₂_{ⁿ})⁻¹, (Q₂_{ⁿ})⁻¹, these inverse matrixes of two identical unitary matrixes (Q₂_{ⁿ})⁻¹, (Q₂_{ⁿ})⁻¹ are configured to transfer a state amplitude of qubits. The matrix form of (Q₂_{ⁿ})⁻¹ is shown as Equation 13 below:

$$( {Q}_{{{2}^{n} )}^{- 1}} = [ \begin{matrix}0 & 0 & 0 & 0 & … & 1 \\ 1 & 0 & 0 & 0 & … & 0 \\ 0 & 1 & 0 & 0 & … & 0 \\ ⋮ & ⋮ & ⋮ & ⋮ & ⋱ & 0 \\ 0 & 0 & 1 & 0 & … & 0 \\ 0 & 0 & 0 & 1 & … & 0\end{matrix} ] \qquad ( Equation 13 )$$

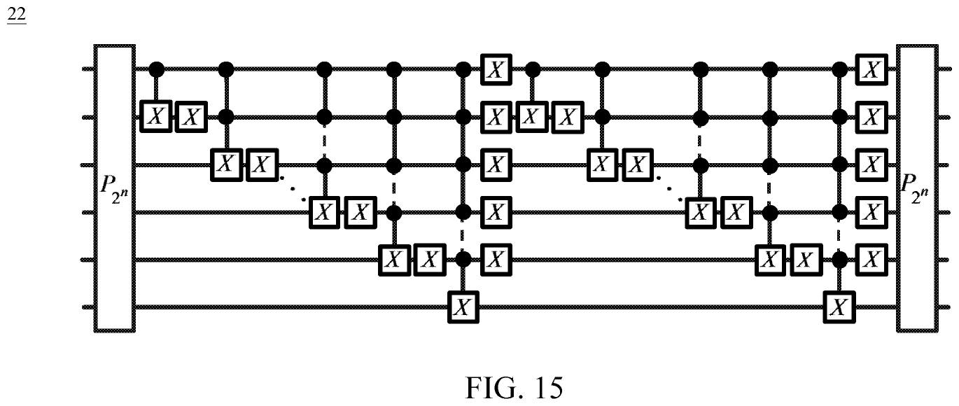

Therefore, the (Q₂_{ⁿ})⁻¹·(Q₂_{ⁿ})⁻¹ quantum circuit 22 may be expanded and implemented according to Equation 13. FIG. 15 is a circuit diagram of the (Q₂_{ⁿ})⁻¹·(Q₂_{ⁿ})⁻¹ quantum circuit 22 in the Coiflet'C6 wavelet inverse transform quantum circuit 20 according to an embodiment of the present disclosure. As described in the above, the (Q₂_{ⁿ})⁻¹·(Q₂_{ⁿ})⁻¹ quantum circuit 22 is configured to receive a second part of the data and generate a first result. The second part includes the data of the first dimension |j₀ [symbol] to the data of the (n−2)^{th} dimension |jₙ₋₃ [symbol] .

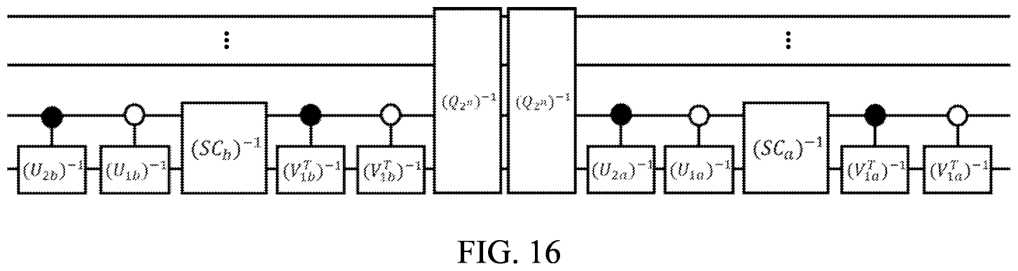

FIG. 16 is a schematic diagram expanding the circuits shown in FIG. 13 and FIG. 14 to FIG. 4. By the above manner, an embodiment of the present disclosure uses qubit logic gates and quantum arrangement to implement the quantum circuit of Coiflet'C6 wavelet inverse transform.

In view of the above, the present disclosure adds the basic concept of quantum to the traditional wavelet transform, and uses quantum logic gates and quantum arrangement to construct the quantum circuit of Coiflet'C6 wavelet transform. The quantum circuits proposed by the present disclosure may be applied to the image compression with large amount of images and signal processing, and has a high-speed and flexible computing method.

What is claimed is:

1. A Coiflet'C6 wavelet transform quantum circuit comprising:
a B quantum circuit configured to receive a first part of data of n-dimension and generate a first intermediate result, wherein the first part comprises the data of (n−1)^{th} dimension and the data of n^{th} dimension;
a Q₂_{ⁿ}·Q₂_{ⁿ} quantum circuit configured to receive a second part of the data and generate a first result, wherein the Q₂_{ⁿ}·Q₂_{ⁿ} quantum circuit is coupled to the B quantum circuit to receive the first intermediate result and generate a second intermediate result, and the second part comprises the data of first dimension to the data of (n−2)^{th} dimension; and
an A quantum circuit coupled to the Q₂_{ⁿ}·Q₂_{ⁿ} quantum circuit to receive the second intermediate result and generate a second result;
wherein n is a positive integer, the B quantum circuit and the A quantum circuit are configured to implement two 4×4 parameter matrixes, the Q₂_{ⁿ}·Q₂_{ⁿ} quantum circuit is configured to implement a dot product of two identical unitary matrixes, the two identical unitary matrixes are configured to transfer a state amplitude of qubits, and the Coiflet'C6 wavelet transform quantum circuit outputs a set of the first result and the second result.

2. The Coiflet'C6 wavelet transform quantum circuit of claim 1, wherein
the A quantum circuit implements U₁ₐ⊕U₂ₐ·SCₐ·V₁ₐ^{T}⊕V₂ₐ^{T}, wherein
the U₁ₐ is
$$Ph ( \frac{π}{2} ) \cdot {R}_{z} ( π ) \cdot {R}_{y} ( 1.86504 π ) \cdot {R}_{z} ( 0 ) ;$$
the U₂ₐ is
$$Ph ( \frac{π}{2} ) \cdot {R}_{z} ( π ) \cdot {R}_{y} ( 0.86504 π ) \cdot {R}_{z} ( 2 π ) ;$$
the SCₐ is R_{y}(0)⊕R_{y}(−0.23π);
the V₁ₐ^{T} and the V₂ₐ^{T} are Pauli-Z gates;
the B quantum circuit implements U_{1b}⊕U_{2b}·SC_{b}·V_{1b}^{T}⊕V_{2b}^{T}, wherein
the U_{1b} and the U_{2b} are Pauli-X gates;
the SC_{b} is R_{y}(0)⊕R_{y}(0.23π);
the V_{1b}^{T} is Ph(π)·R_{z}(π)·R_{y}(0.13495π)·R_{z}(0);
the V_{2b}^{T} is Ph(π)·R_{z}(π)·R_{y}(1.13496π)·R_{z}(π);
wherein the Ph is a phase-shift gate, the R_{z} is a rotation-Z gate, and the R_{y} is a rotation-Y gate.

3. A manufacturing method of a Coiflet'C6 wavelet transform quantum circuit comprising:
decomposing a matrix C₂_{ⁿ}⁽⁶⁾ of a Coiflet'C6 wavelet into (I₂_{^{n−2}}⊗A)·Q₂_{ⁿ}·Q₂_{ⁿ}·(I₂_{^{n−2}}⊗B);
decomposing the A into U₁ₐ⊕U₂ₐ·SCₐ·V₁ₐ^{T}⊕V₂ₐ^{T};
decomposing the B into U_{1b}⊕U_{2b}·SC_{b}·V_{1b}^{T}⊕V_{2b}^{T}; and
constructing the Coiflet'C6 wavelet transform quantum circuit by a plurality of qubit logic gates according to the (I₂_{^{n−2}}⊗A)·Q₂_{ⁿ}·Q₂_{ⁿ}·(I₂_{^{n−2}}⊗B), the U₁ₐ⊕U₂ₐ·SCₐ·V₁ₐ^{T}⊕V₂ₐ^{T}, and the U_{1b}⊕U_{2b}·SC_{b}·V_{1b}^{T}⊕V_{2b}^{T};
wherein the Q₂_{ⁿ} is a 2ⁿ×2ⁿ unitary matrix ;
the U₁ₐ is
$$Ph ( \frac{π}{2} ) \cdot {R}_{z} ( π ) \cdot {R}_{y} ( 1.86504 π ) \cdot {R}_{z} ( 0 ) ;$$
the U₂ₐ is
$$Ph ( \frac{π}{2} ) \cdot {R}_{z} ( π ) \cdot {R}_{y} ( 0.86504 π ) \cdot {R}_{z} ( 2 π ) ;$$
the SCₐ is R_{y}(0)⊕R_{y}(−0.23π);
the V₁ₐ^{T} and the V₂ₐ^{T} are Pauli-Z gates;
the U_{1b} and the U_{2b} are Pauli-X gates;
the SC_{b} is R_{y}(0)⊕R_{y}(0.23π);
the V_{1b}^{T} is Ph(π)·R_{z}(π)·R_{y}(0.13495π)·R_{z}(0);
the V_{2b}^{T} is Ph(π)·R_{z}(π)·R_{y}(1.13496π)·R_{z}(π);
wherein the Ph is a phase-shift gate, the R_{z} is a rotation-Z gate, and the R_{y} is a rotation-Y gate.

4. A Coiflet'C6 wavelet inverse transform quantum circuit comprising:
an (A)⁻¹quantum circuit configured to receive a first part of data of n-dimension and generate a first intermediate result, wherein the first part comprises the data of (n−1)^{th} dimension and the data of n^{th} dimension;
a (Q₂_{ⁿ})⁻¹·(Q₂_{ⁿ})⁻¹ quantum circuit configured to receive a second part of the data and generate a first result, wherein the (Q₂_{ⁿ})⁻¹·(Q₂_{ⁿ})⁻¹ quantum circuit is coupled to the (A)⁻¹ quantum circuit to receive the first intermediate result and generate a second intermediate result, and the second part comprises the data of first dimension to the data of (n−2)^{th} dimension; and
a (B)⁻¹ quantum circuit coupled to the (Q₂_{ⁿ})⁻¹·(Q₂_{ⁿ})⁻¹ quantum circuit to receive the second intermediate result and generate a second result;
wherein n is a positive integer, the (A)⁻¹ quantum circuit and the (B)⁻¹ quantum circuit are configured to implement inverse matrixes of two 4×4 parameter matrixes, the (Q₂_{ⁿ})⁻¹·(Q₂_{ⁿ})⁻¹ quantum circuit is configured to implement a dot product of inverse matrixes of two identical unitary matrixes, the two identical unitary matrixes are configured to transfer a state amplitude of qubits, and the Coiflet'C6 wavelet inverse transform quantum circuit outputs a set of the first result and the second result.

5. The Coiflet'C6 wavelet inverse transform quantum circuit of claim 4, wherein
the (A)⁻¹ quantum circuit implements (V₂ₐ^{T})⁻¹⊕(V₁ₐ^{T})⁻¹·(SCₐ)⁻¹·(U₂ₐ)⁻¹⊕(U₁ₐ)⁻¹, wherein
the V₂ₐ^{T} and the V₁ₐ^{T} are Pauli-Z gates;
the SCₐ is R_{y}(0)·R_{y}(−0.23π);
the U₂ₐ is
$$Ph ( \frac{π}{2} ) \cdot {R}_{z} ( π ) \cdot {R}_{y} ( 0.86504 π ) \cdot {R}_{z} ( 2 π ) ;$$
the U₁ₐ is
$$Ph ( \frac{π}{2} ) \cdot {R}_{z} ( π ) \cdot {R}_{y} ( 1.86504 π ) \cdot {R}_{z} ( 0 ) ;$$
the (B)⁻¹ quantum circuit implements (V_{2b}^{T})⁻¹⊕(V_{1b}^{T})⁻¹·(SC_{b})⁻¹·(U_{2b})⁻¹⊕(U_{1b})⁻¹, wherein
the V_{2b}^{T} is Ph(π)·R_{z}(π)·R_{y}(1.13496π)·R_{z}(π);
the V_{1b}^{T} is Ph(π)·R_{z}(π)·R_{y}(0.13495π)·R_{z}(0);
the SC_{b} is R_{y}(0)⊕R_{y}(0.23π);
the U_{2b} and the U_{1b} are Pauli-X gates;
wherein the R_{y} is a rotation-Y gate, the Ph is a phase-shift gate, and the R_{z} is a rotation-Z gate.
